(19) United States
(12) Patent Application Publication
(10) Pub. No.: US 2005/0226104 A1
(43) Pub. Date: Oct. 13, 2005

(54) Information record/replay apparatus and method

(75) Inventors: Masatsugu Nishida, Kawasaki (JP); Akira Minami, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/137,316

(22) Filed: May 25, 2005

Related U.S. Application Data
(63) Continuation of application No. PCT/JP03/07155, filed on Jun. 5, 2003.

(51) Int. Cl. G11B 7/085; G11B 5/09

(52) U.S. Cl. 369/30.1; 369/47.38

(57) ABSTRACT

In an information record/replay apparatus for writing information to, and reading information from, a disk medium while communicating with a host apparatus by way of an interface having a first transfer mode and a second transfer mode with a lower transfer speed than the first transfer mode, an operation for writing to the disk medium is controlled by assigning a higher rotation speed or shorter seek time than that of the first transfer mode when the second transfer mode is specified.

### CROSS REFERENCE TO RELATED APPLICATION

This application is a continuation application of International PCT Application No. PCT/JPO3/07155 which was filed on Jun. 05, 2003.

### BACKGROUND OF THE INVENTION

1. Field of the Invention

The present invention relates to an information record/replay apparatus for writing information to a disk media and reading information from thereof while communicating with a host apparatus by way of an interface which supports a plurality of transfer modes of different transfer speeds and to an information recording method for use in such an information record/replay apparatus.

2. Description of the Related Art

The universal serial bus interface (USB Interface) has been widely used as an interface for PC peripheral apparatuses in recent years because of its good connectivity, such as allowing connection and disconnection with the host apparatus, that is, the personal computer (PC), while being turned on.

Today, the trend in adopting USB for peripheral apparatus that originated from the low/middle speeds such as mice, keyboards, printers, scanners, et cetera, is now spreading to the middle/high speeds such as flexible disk drives (FDD), hard disk drives (HDD), magneto-optical disk drives (MOD), CD-ROM (compact disk-read only memory), AV (audio and visual) equipment. The USB cable contains a power cable, capable of supplying power (USB bus power) from a PC to a peripheral apparatus.

The current USB standard provides three transfer modes (i.e., theoretical maximum transfer speed for each of the following), that is, low speed (1.5 Mbps), full speed (12 Mbps) and high speed (480 Mbps) . There is a possibility, however, that the specified high speed mode only gains an even lower actual transfer speed than the full speed due to the limitation of power consumption specified by the USB standard.

In a high speed-capable USB power-driven optical disk drive, for example, the native transfer speed of the drive cannot be raised above a certain level due to the maximum allowable current of 500 mA specified by USB specification Rev. 2.0, resulting in the native transfer speed of the optical disk drive being lower than the maximum transfer speed of the full speed specification.

In this case, the relationships between the native transfer speed of the drive and the maximum transfer speeds of the full and high speed specifications for data writing and reading are as follows:

For writing:

Transfer speed of drive <full speed <high speed

For reading:

Full speed <transfer speed of drive <high speed

Therefore, the transfer speed for reading is determined by the native transfer speed of the drive when the high speed is specified, while gaining the maximum transfer speed of 12 Mbps for the full speed when the full speed is specified.

Contrary to the above, the transfer speed for writing is determined by the native transfer speed of the drive in either of the full or high speed specifications, and is thus unable to exceed a limited speed due to the allowable consumption current for the high speed specification. This necessitates an improvement of transfer speed for writing.

There is a known technique noted by patent document 1, for example, as a method for optimizing a system, by a host apparatus transmitting a performance parameter to and receiving it from an HDD connected therewith by an interface.
Patent document 1: Japanese unexamined patent application publication No. 2001-222380

### SUMMARY OF THE INVENTION

The object of the present invention is to improve the transfer speed for data writing under certain conditions in an information record/replay apparatus, such as an optical disk drive, which writes information to, and reads information from, a disk medium while communicating with a host apparatus by way of an interface that supports a plurality of transfer modes with various speeds such as USB.

An information record/replay apparatus in a first aspect according to the present invention comprises a motor unit for rotating a disk medium, a process unit and a control unit; and writes information to, and reads information from, a disk medium while communicating with a host apparatus by way of an interface that has a first transfer mode, and a second transfer mode with a lower transfer speed than that of the first transfer mode. The process unit specifies a predetermined rotation speed as a rotation speed of the disk medium when the first transfer mode is specified, while specifying a higher rotation speed than the predetermined rotation speed as the rotation speed of the disk medium when the second transfer mode is specified. The control unit accordingly controls the motor unit in accordance with the rotation speed specified by the process unit.

In a second aspect of the present invention, the above noted interface comprises a power cable, the above noted information record/replay apparatus operates on the power supplied from the host apparatus by way of the power cable, the above noted predetermined rotation speed is decided based on the consumption current of the information record/replay apparatus in the first transfer mode, and the process unit sets the rotation speed of the disk medium to a higher speed than the predetermined rotation speed within the allowable range of current supplied by the host apparatus when the second transfer mode is specified.

An information record/replay apparatus in a third aspect of the present invention comprises a head unit for writing in formation to and reading information from a disk medium, a process unit and a control unit; and communicates with a host apparatus by way of an interface that has a first transfer mode, and a second transfer mode with a lower transfer speed than that of the first transfer mode. The process unit specifies a predetermined seek time as a seek time of the head unit when the first transfer mode is specified, and a seek time shorter than the predetermined seek time as the seek time of the head unit when the second transfer mode is specified. The control unit accordingly controls the head unit in accordance with the seek time specified by the process unit.

In a fourth aspect of the present invention, the above noted interface comprises a power cable, the above noted information record/replay apparatus operates on the power supplied by the host apparatus by way of the power cable, the above noted predetermined seek time is decided based on the consumption current of the information record/replay apparatus in the first transfer mode, and the process unit reduces the seek time of the head unit to a valueless than the predetermined seek time within the allowable range of current supplied by the host apparatus when the second transfer mode is specified.

### BRIEF DESCRIPTION OF THE DRAWINGS

FIG. 1 shows a connection diagram of an optical disk drive with a PC;

FIG. 2 is a block diagram of an optical disk drive;

FIG. 3 is a summary configuration inside an enclosure;

FIG. 4 shows a consumption current waveform in a high speed transfer mode;

FIG. 5 shows a first consumption current waveform in a full speed transfer mode;

FIG. 6 shows a second consumption current waveform in a full speed transfer mode;

FIG. 7 is a flowchart of an operation of an optical disk drive;

FIG. 8 is a flow chart of processing by a PC;

FIG. 9 illustrates a front view of an optical disk drive;

FIG. 10 is a schematic diagram of a first LED circuit;

FIG. 11 shows display modes of the first LED circuit;

FIG. 12 is a schematic diagram of a second LED circuit; and

FIG. 13 shows display modes of the second LED circuit.

### DESCRIPTION OF THE PREFERRED EMBODIMENTS

An embodiment according to the present invention will be described in detail while referring to the accompanying drawings in the following.

The present embodiment improves the performance of an information record/replay apparatus, which operates on the power supplied through the USB interface, by switching the operation mode according to a result of communication with a host apparatus in a higher level.

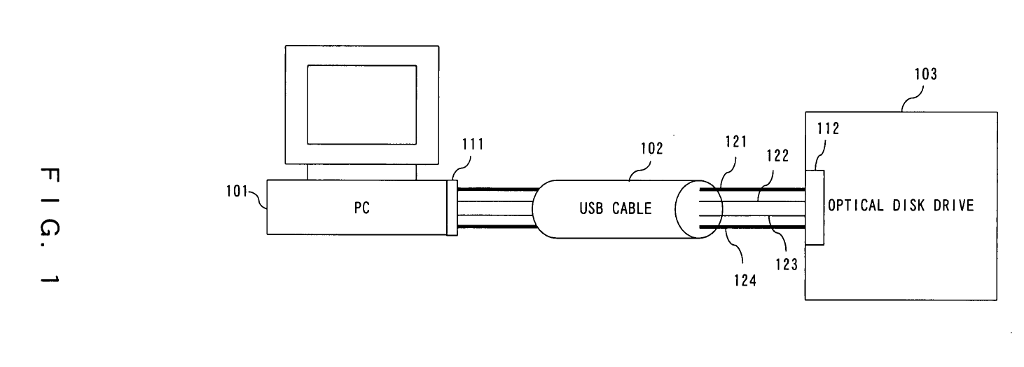

FIG. 1 shows a diagram of connecting an optical disk drive, i.e., the information record/replay apparatus (as a USB device), with a PC, i.e., the host apparatus by a USB cable. The USB cable 102, comprising a power line (VBUS) 121, a signal line (D+) 122, a signal line (D−) 123 and a power line (GND, i.e., ground) 124; is connected to a USB connector 111 of a PC 101 and a USB connector 112 of an optical disk drive 103. The PC 101 is capable of supplying power (i.e., USB bus power) to the optical disk drive 103 by way of the power lines 121 and 124.

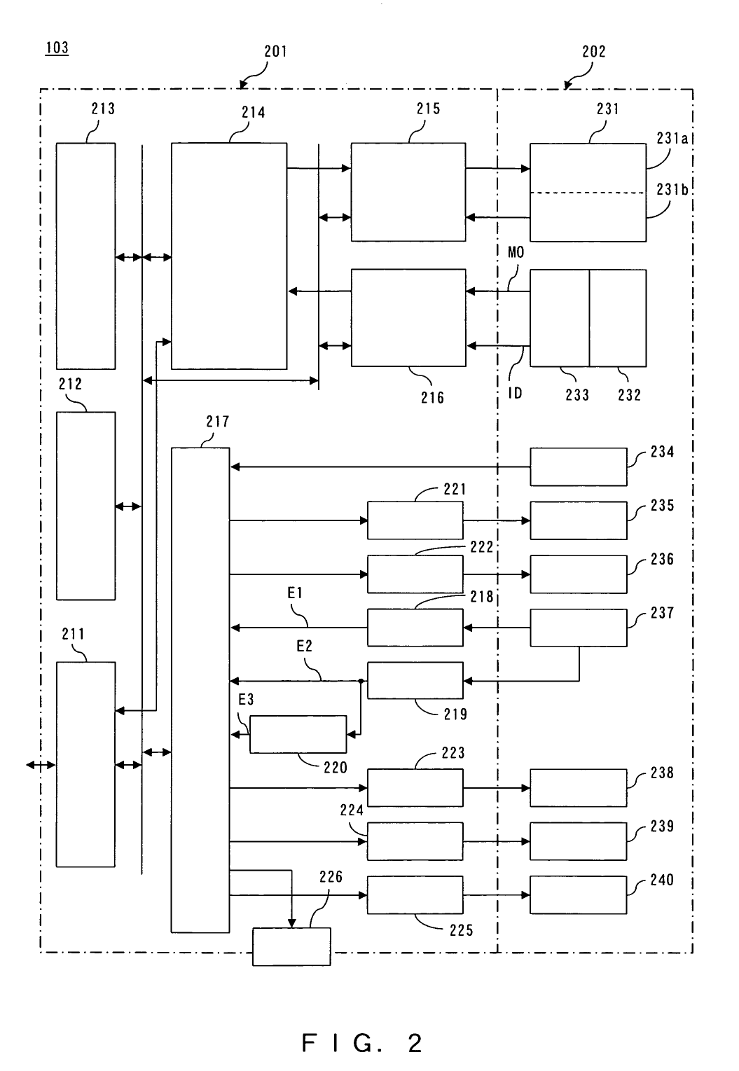

FIG. 2 is a block diagram of an example of an optical disk drive 103. The optical disk drive 103 comprises a control unit 201 and an enclosure 202, which writes information to, and reads information from, a magneto-optical disk (MO) medium.

The control unit 201 comprises an interface controller 211, buffer memory 212, an MPU (micro processing unit) 213, an optical disk controller (ODC) 214, a write LSI (large-scale integration) 215, a read LSI 216, a DSP (digital signal processor)/user logic 217, a focus error signal (FES) detection circuit 218, a tracking error signal (TES) detection circuit 219, a track zero cross (TZC) detection circuit 220, drivers 221 through 225 and a light-emitting diode (LED) circuit 226.

And the enclosure 202 comprises a laser diode unit 231, an ID/MO detector 232, a head amplifier 233, a temperature sensor 234, a spindle motor 235, a magnetization unit 236, a multiple division detector 237, a focus actuator 238, a lens actuator 239, and a voice coil motor (VCM) 240.

The interface controller 211 controls the USB interface to exchange commands and data with the PC 101. The buffer memory 212 is shared by the interface controller 211, MPU 213 and optical disk controller 214, and is used as a working memory area. The MPU 213 controls the overall optical disk drive 103.

The optical disk controller 214 performs processing necessary for reading/writing to an M medium. The write LSI 215, incorporating a write modulation circuit and a laser diode control circuit, converts write data, which is coming from the optical disk controller 214, to either PPM (pit position modulation) or PWM (pulse width modulation) data for recording depending on the media category and supplies the data to the laser diode unit 231 comprised by the enclosure 202.

The laser diode unit 231 incorporates a laser diode 231a and a monitoring detector 231b. The laser diode 231a emits light according to the data from the write LSI 215. The for-monitor detector 231b detects the emission intensity of the laser diode 231a for supplying to the write LSI 215.

The read LSI 216, incorporating a read demodulation circuit and a frequency synthesizer, generates a read clock and read data from the ID and MO signals supplied by the enclosure 202 to restore the original data.

The DSP 217 performs various servo controls based on a temperature signal from the temperature sensor 234 of the enclosure 202, a focus error signal El from the focus error signal detection circuit 218, a tracking error signal E2 from the tracking error signal detection circuit 219 and a zero-cross signal E3 from the track zero cross detection circuit 220.

The focus error signal detection circuit 218 detects a focus error signal El based on a signal detected by the multiple division detector 237 of the enclosure 202. The tracking error signal detection circuit 219 detects a tracking error signal E2 based on a signal detected by the multiple division detector 237 of the enclosure 202. The track zero cross detection circuit 220 detects a zero-cross signal E3 based on the tracking error signal E2.

The driver 221 drives the spindle motor 235 according to a drive signal from the DSP 217 to rotate an MO medium. The driver 222 drives the magnetization unit 236 according to a magnetic field generation signal from the DSP 217. The magnetization unit 236, comprising an electromagnet, is configured to vary a magnetic field applied to an MO medium according to a drive signal from the driver 222. The magnetization unit 236 may be either of the levitation type which is levitated from the medium by a magnetizing head being comprised by a magnetic pole wound with a coil, or of the contact type which contacts with the medium.

The driver 223 drives the focus actuator 238 according to a focus control signal from the DSP 217. The driver 224 drives the lens actuator 239 according to atracking control signal from the DSP 217. The driver 225 drives the VCM 240 according to a VCM control signal from the DSP 217.

The LED circuit 226, incorporating an LED equipped on the surface of the control unit 201, displays the operating mode (i.e., transfer mode) of the apparatus by causing the LED to emit according to an LED control signal from the DSP 217.

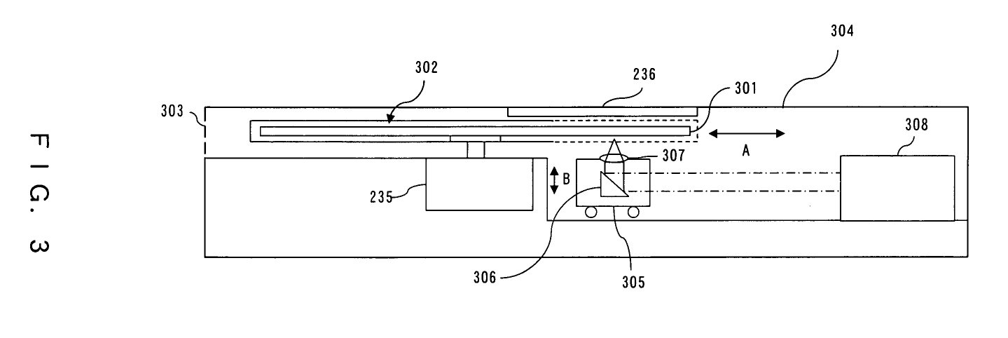

FIG. 3 is a summary configuration of the interior of the enclosure 202. An MO cartridge 302 incorporating an MO medium 301 is loaded into a housing 304 from a loading slot 303. The MO medium 301 is engaged with the spindle motor 235 inside the housing 304.

Meanwhile, inside the housing 304, the shutter of the MO cartridge 302 is opened to expose the MO medium 301 which is then held between a carriage 305 comprising the optical head and the magnetization unit 236 inside the housing 304.

The carriage 305 is configured to be moved by the VCM 240 in the radial direction of the MO medium 301 (i.e., the direction of arrow A) and is mounted with a prism 306 and an objective lens 307.

The prism 306 deflects a laser beam from a fixed optical system 308 to the direction of the MO medium 301, while the objective lens 307 focuses the laser beam from the prism 306 onto the MO medium 301. Focusing of the objective lens 307 is controlled by the focus actuator 238, which is mounted on the carriage 305, swinging the objective lens 307 in the direction of arrow B. Meanwhile, tracking is controlled by the lens actuator 239, which is mounted on the carriage 305, swinging the objective lens 307 in the direction of arrow A.

Note that the present embodiment controls the tracking by using the VCM 240 and lens actuator 239. However, the tracking control may be accomplished by the VCM 240 alone, thus eliminating a lens actuator 239.

Since the consumption current of the interface controller 211 of the drive 103 for the full speed transfer mode is smaller than for the high speed, the overall consumption current of the drive 103 is reduced, and therefore there is a surplus vis-a-vis the allowable consumption current of 500 mA.

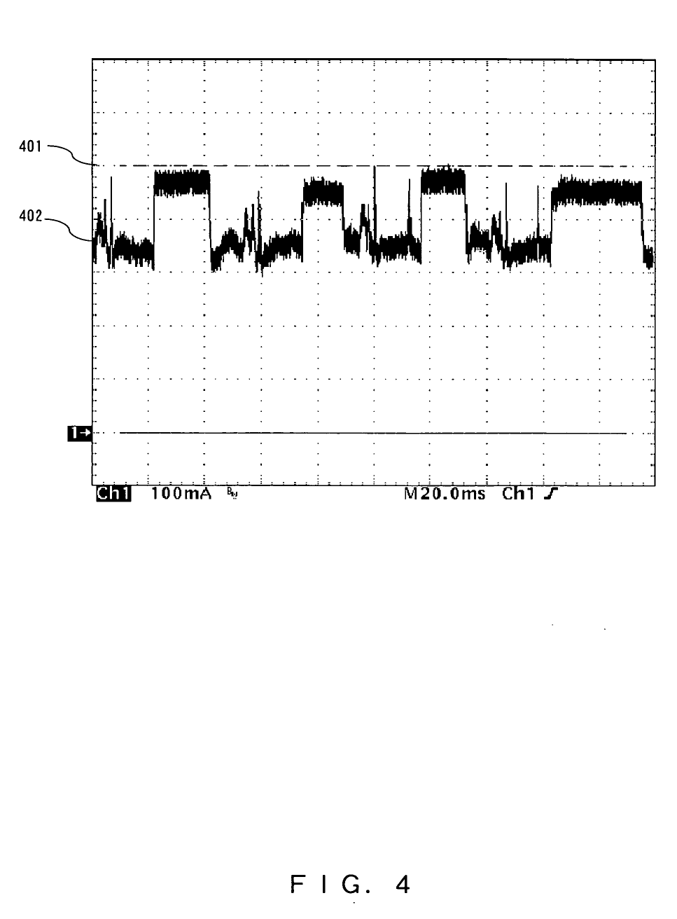

FIG. 4 exemplifies a consumption current waveform for the high speed transfer mode. The horizontal axis indicates an elapsed time and the vertical axis indicates the current. In this example the current of the consumption current wave 402 is less than the allowable consumption current (500 mA) 401, where the corresponding rotation speed of the disk medium (MO medium) is 4000 rpm.

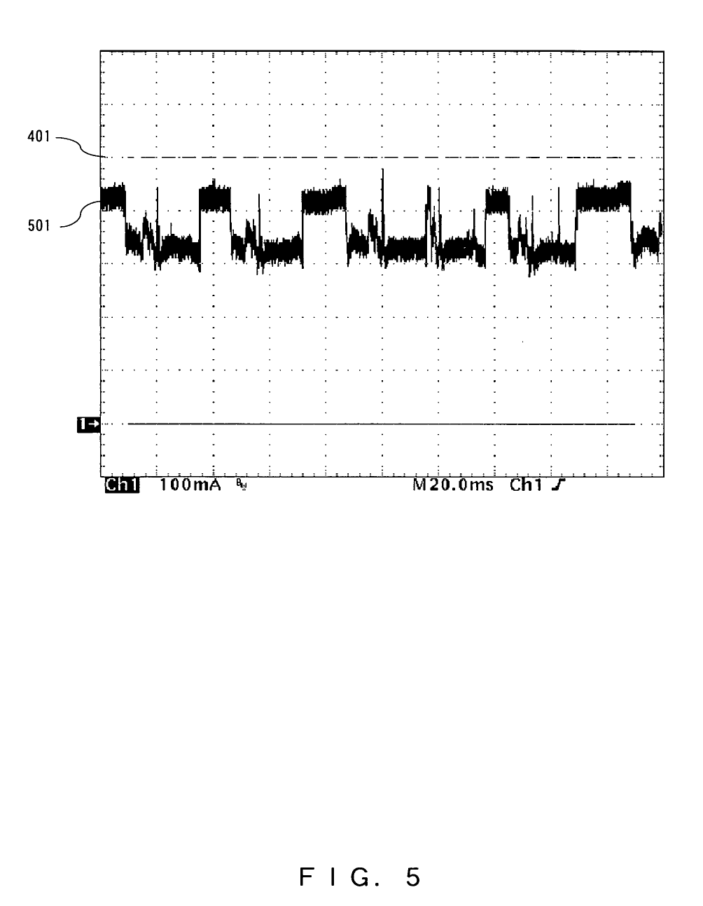

In the meantime, the consumption current waveform for the full speed in the case of the same rotation speed, is as shown by FIG. 5 in which the current of a consumption current wave 501 is a little less than that of the consumption current wave 402 in FIG. 4 and thus less than the allowable consumption current 401. An effective use of the difference in the current makes it possible to improve the performance of the drive 103.

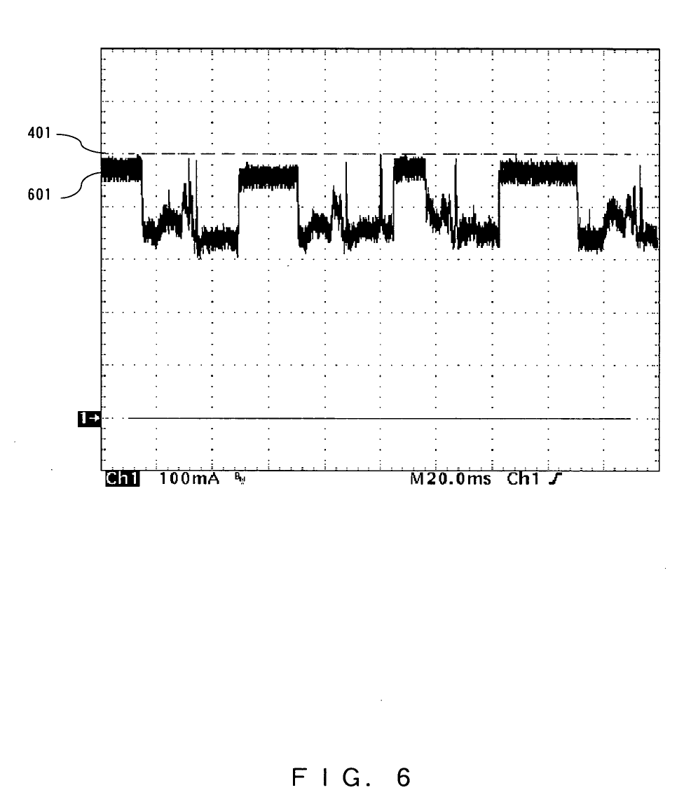

Accordingly, a normal rotation speed is used for an operation at the high speed, while a higher rotation speed is used for that at the full speed, taking advantage of the surplus current. For example, if the rotation speed for the full speed is increased from 400 rpm to 4500 rpm, the consumption current wave form changes as shown by FIG. 6, making the current of a consumption current wave 601 approach the allowable consumption current 401.

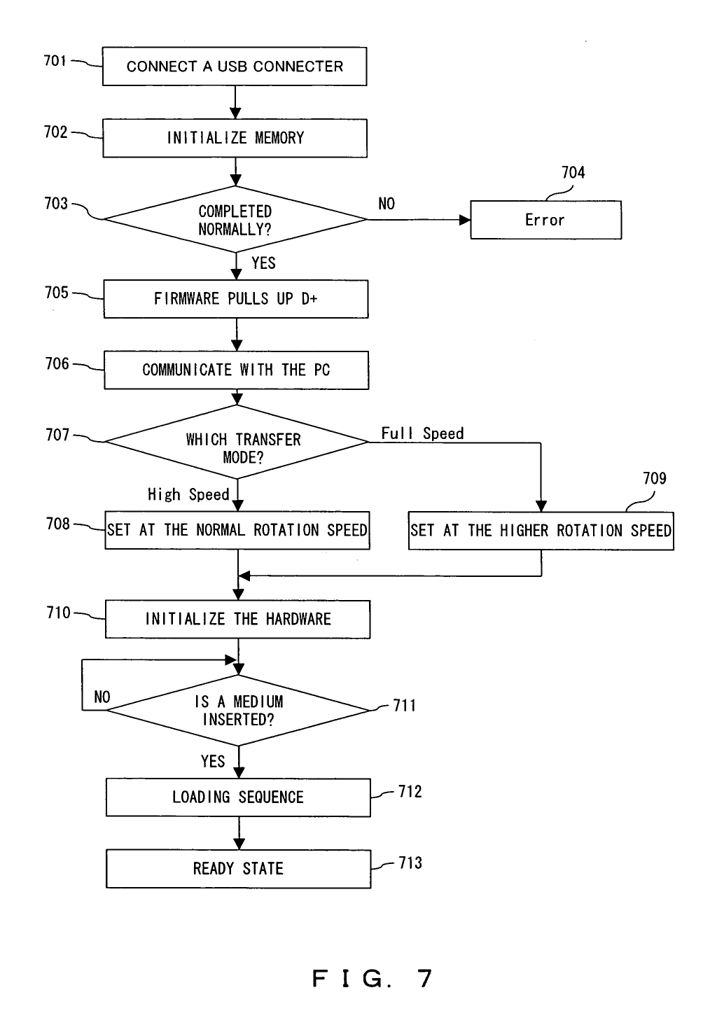

FIG. 7 is a flow chart showing an operation of the optical disk drive 103 in the case of such rotation speed control.

First of all, when the PC 101 is connected to the optical disk drive 103 with the USB cable 102, power is supplied to the optical disk drive 103 (power on) (step 701) and the optical disk drive 103 initializes the buffer memory 212 (step 702).

Then, the optical disk drive 103 checks whether or not the initialization is completed normally (step 703) and, if it is not completed normally, performs error processing (step 704). Upon finishing the initialization, the firmware (i.e., MPU 213) pulls up a D+ signal (step 705) to start communicating with the PC 101 (step 706).

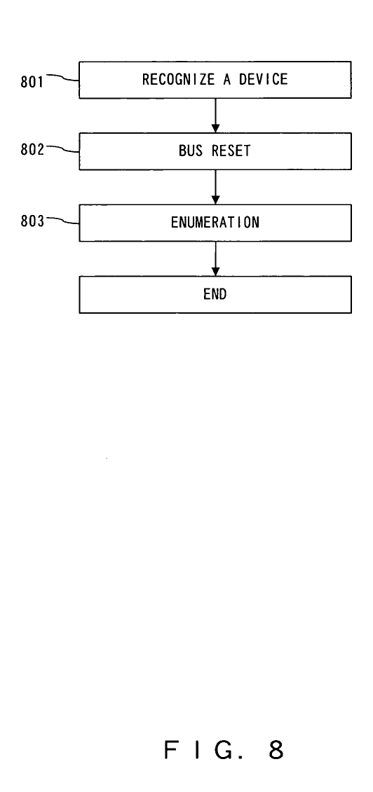

FIG. 8 is a flow chart of processing by the PC 101 in the step 706 shown by FIG. 7. The PC 101 recognizes the connection of the device by the D+ signal being pulled up (step 801) and sends a bus reset command to the optical disk drive 103 (step 802).

Upon issuing the bus reset command, the interface controller 211 and the PC 101 communicate with each other to establish either the high speed or the full speed as the transfer mode of the interface. At this point, if the PC 101 is high speed-capable (i.e., USB 2.0-capable), a transfer mode is identified by the chirp handshake. If the PC 101 is full speed-capable (i.e., USB 1.1-capable), the transfer mode is identified as the full speed by the fact that the D+ is pulled up.

Meanwhile, following the bus reset, the PC 101 performs device enumeration for address allocation and various settings (step 803). This processing establishes the optical disk drive 103 as a USB bus powered device and following the enumeration the optical disk drive 103 becomes capable of consuming a current of 500 mA maximum.

Next, the MPU 213 comprised by the optical disk drive 103 judges an established transfer mode (step 707) and, if it is the high speed, sets up the control information according to the normal rotation speed (step 708), whereas if the transfer mode is the full speed, it sets up the control in formation according to a rotation speed higher than that of the high speed (step 709). The rotation speed is decided so that the consumption current of the whole drive is within the allowable consumption current.

Control information dependant on rotation speed is set to registers in the optical disk controller 214 and DSP 217 to be used for the read/write clock control and for drive control of the spindle motor 235.

Subsequently, the optical disk drive 103 initializes the hardware (step 710) and performs cartridge sensing (step 711), and then, as an MO medium 301 is inserted, performs a loading sequence (step 712), hence attaining a ready state (step 713).

Such a rotation speed control makes it possible to drive the optical disk drive 103 at a higher rotation speed for the full speed transfer mode than that for the high speed, thereby speeding up the transfer speed for writing data under the limitation of allowable consumption current.

While the present embodiment has adopted a USB bus powered device in the description so far, the present invention can also be applied to an apparatus operating on an exclusive power supply, instead of being limited to the USB bus powered device. Also, a discretionary apparatus in a higher level being capable of communication with a USB device can be applied as a host apparatus instead of being limited to a PC.

Meanwhile, the seek time of a head positioner (i.e., carriage 305) can be switched instead of switching the rotation speed corresponding to the transfer mode. The seek time is defined as an elapsed time for the head reaching the writing position (or reading position) of the disk medium. As the seek time becomes shorter the consumption current of the VCM 240 increases.

In this case the MPU 213 sets the control information according to the normal seek time in step 708 shown by FIG. 7 (in the case of high speed) and the control information according to a seek time shorter than that for the high speed in step 709 (in the case of full speed). The seek time, incidentally, is decided within a range where a consumption current of the whole drive does not exceed the allowable consumption current.

The seek time-dependent control information is set to a register in the DSP 217 to be used for drive control for the VCM 240.

Such a seek time control makes it possible to drive the optical disk drive 103 for the transfer mode of the full speed at a shorter seek time than for the high speed, thereby gaining a higher transfer speed for writing data under the limitation of the allowable consumption current.

Furthermore, it is also possible to combine the above described rotation speed control with the seek time control.

In this case, the MPU 213 sets the control information according to the normal rotation speed and seek time in step 708 shown by FIG. 7 (in the case of the high speed) and the control information according to a higher rotation speed and shorter seek time than those for the high speed in step 709 (in the case of the full speed). The rotation speed and seek time, incidentally, are determined within a range where a consumption current of the whole drive does not exceed the allowable consumption current.

The color, flashing cycle, intensity, et cetera, of the LED furnished in the control unit 201 can indicate which of the high speed and the full speed the transfer mode established by the communication between the PC 101 and optical disk drive 103 is. Furnishing such a configured LED makes the optical disk drive 103 a user friendly apparatus.

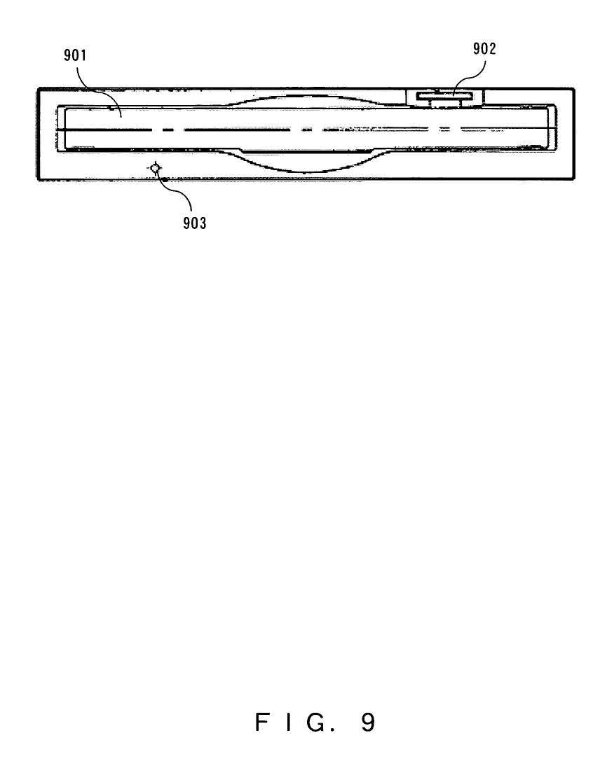

FIG. 9 illustrates the front view of the optical disk drive 103, showing a disk loading slot 901, a media eject button 902 and a manual ejection hole 903. The eject button 902 is shared by the indicator window for a power/busy(access) LED.

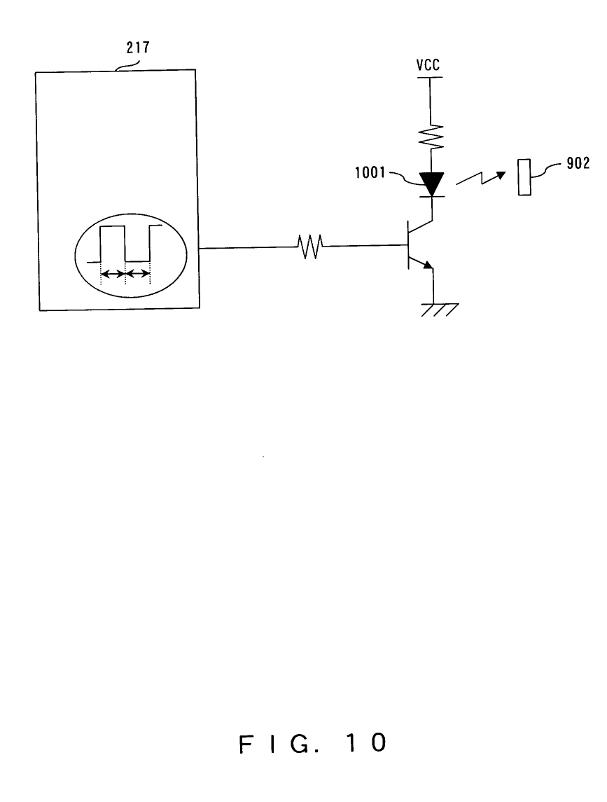

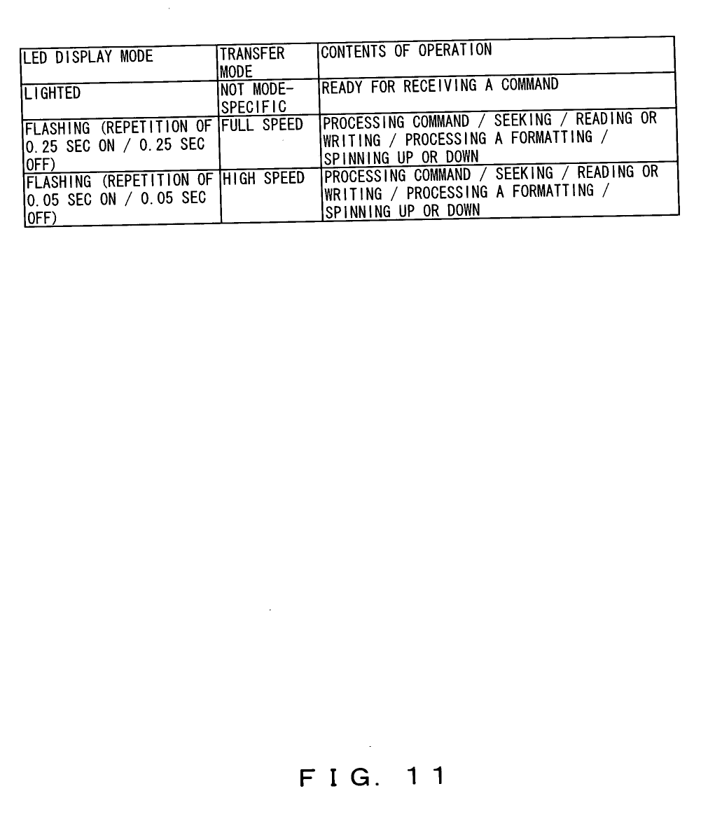

The first description is of a configuration for changing the flashing cycle of the LED according to the transfer mode. In this case the schematic diagram of the LED circuit 226 is as shown by FIG. 10 so as to notify the operator of the transfer mode of the interface and the processing state by the lighting and flashing cycles of the LED. FIG. 11 shows the relationship among the LED displaying mode, transfer mode and operational content.

The MPU 213 sets an interval of 250 ms at the register for setting a flashing cycle within the DSP 217 in the case of the full speed transfer mode, and an interval of 50 ms at the register in the case of the high speed. An LED 1001 flashes at the flashing cycle set at the DSP 217. Therefore, the LED 1001 flashes at a shorter interval at the high speed than at the full speed, enabling the operator to recognize the transfer mode of the optical disk drive 103 easily.

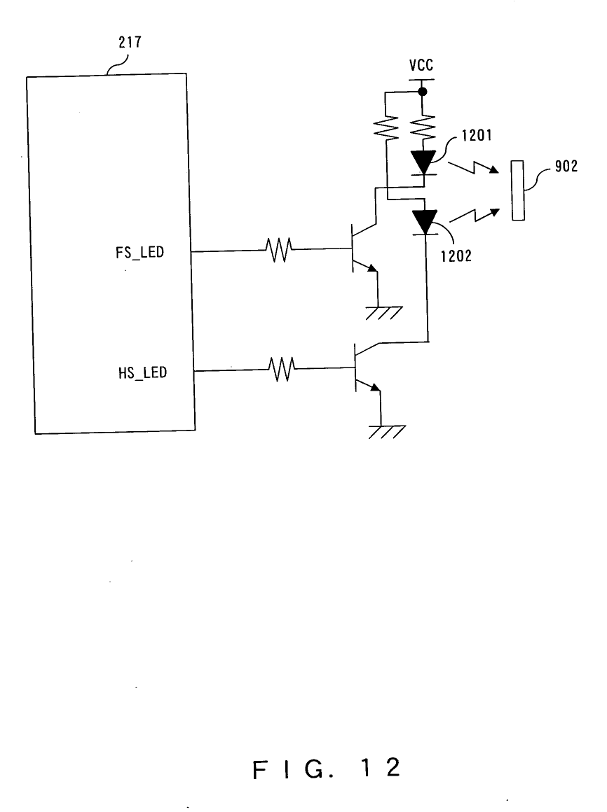

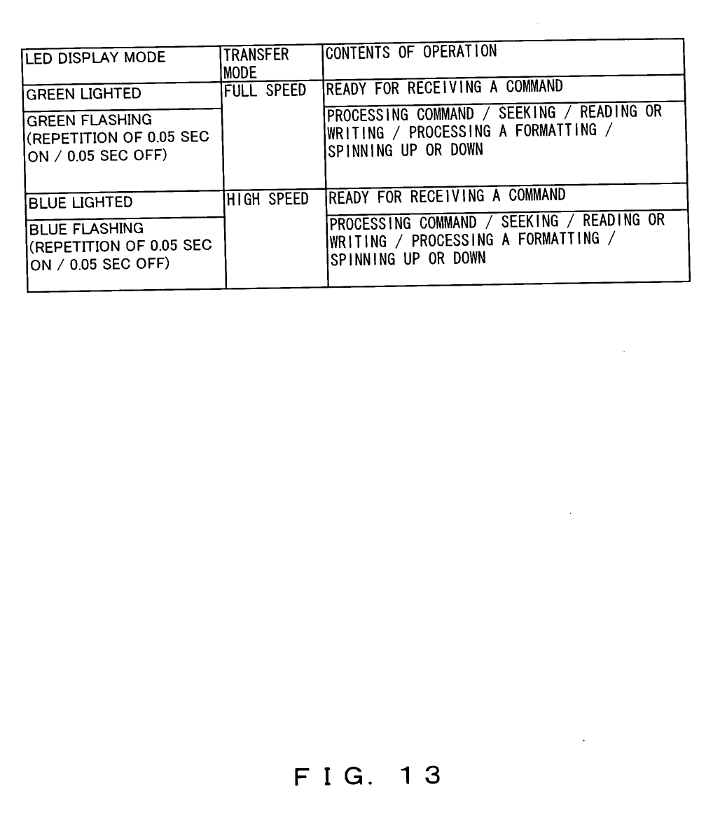

The next description is of a configuration for changing the color of an LED. In this case the configuration of the LED circuit 226 is as shown by FIG. 12 so as to notify the operator of the transfer mode of the interface by the color of the LED and of the processing state by the lighting and flashing cycle thereof. FIG. 13 shows the relationship among the LED displaying mode, transfer mode and operational content.

The DSP 217 drives a green LED 1201 by the FS_LED signal for the full speed transfer mode, and a blue LED 1202 by the HS_LED signal for the high speed mode. The different colors of the LEDs enable the operator to recognize the transfer mode of the optical disk drive 103 easily. It goes without saying that other colors of LED may be used.

Incidentally, in the communication between the PC 101 and optical disk drive 103 shown by FIG. 7, the PC 101 identifies the transfer mode of the optical disk drive 103 as the full speed for the duration between connection of a USB connector (i.e., plug in) and establishment of transfer mode. Accordingly, the optical disk drive 103 lights the green LED 1201 at first, followed by switching to the blue LED 1202 at the time of establishing the transfer mode for the high speed or at the completion of enumeration. Alternatively, the configuration may be to not light any LED until the completion of enumeration.

Furthermore, the flashing cycle of the blue LED 1202 may be set at a shorter cycle than that of the green LED 1201 in the same way as FIG. 10.

According to the present invention, it is possible to improve a transfer speed for writing data within the allowable limit of a power source in an information record/replay apparatus, such as an optical disk drive, for writing information to, and reading information from, a disk medium while communicating with a host apparatus by way of an interface supporting a plurality of transfer modes with different transfer speeds, and the performance of the apparatus can be improved.

Particularly, in an information record/replay apparatus which communicates with a host apparatus by way of a USB interface, the transfer speed for writing data in the full speed transfer mode can be improved within the allowable limit of power source.

1. An information record/replay apparatus which has a motor unit for rotating a disk medium and which writes information to, and reads information from, a disk medium while communicating with a host apparatus by way of an interface that has a first transfer mode and a second transfer mode with a lower transfer speed than the first transfer mode, comprising:
a process unit which specifies a predetermined rotation speed as a rotation speed of the disk medium when the first transfer mode is specified, while specifying a higher rotation speed than the predetermined rotation speed as the rotation speed of the disk medium when the second transfer mode is specified; and
a control unit which controls the motor unit in accordance with the rotation speed specified by the process unit.

2. The information record/replay apparatus according to claim 1, wherein said interface comprises a power cable, said information record/replay apparatus operates on power supplied from said host apparatus by way of the power cable, said predetermined rotation speed is decided based on a consumption current of the information record/replay apparatus in said first transfer mode, and said process unit sets the rotation speed of the disk medium at a higher speed than the predetermined rotation speed within an allowable range of current supplied by the host apparatus when said second transfer is specified.

3. The information record/replay apparatus according to claim 1, further comprising a light emitting diode circuit for indicating which of said first and second transfer modes a current transfer mode of the information record/replay apparatus is.

4. The information record/replay apparatus according to claim 1, wherein said interface is a universal serial bus interface having a high speed transfer mode as the first transfer mode and a full speed transfer mode as the second transfer mode.

5. An information record/replay apparatus which has a head unit for writing information to, and reading information from, a disk medium and which communicates with a host apparatus by way of an interface that has a first transfer mode and a second transfer mode with a lower transfer speed than the first transfer mode, comprising:
a process unit which specifies a predetermined seek time as a seek time of the head unit when the first transfer mode is specified, while specifying a seek time shorter than the predetermined seek time as the seek time of the head unit when the second transfer mode is specified; and
a control unit which controls the head unit in accordance with the seek time specified by the process unit.

6. The information record/replay apparatus according to claim 5, wherein said interface comprises a power cable, said information record/replay apparatus operates on power supplied from said host apparatus by way of the power cable, said predetermined seek time is decided based on a consumption current of the information record/replay apparatus in the first transfer mode, and said process unit reduces the seek time of the head unit to a valueless than the predetermined seek time within an allowable range of current supplied by the host apparatus when said second transfer mode is specified.

7. The information record/replay apparatus according to claim 5, further comprising a light emitting diode circuit for indicating which of said first and second transfer modes a current transfer mode of the information record/replay apparatus is.

8. The information record/replay apparatus according to claim 5, wherein said interface has a high speed transfer mode as the first transfer mode and a full speed transfer mode as the second transfer mode.

9. An information recording method for an information record/replay apparatus for writing information in, and reading information from, a disk medium while communicating with a host apparatus by way of an interface that has a first transfer mode and a second transfer mode with a lower transfer speed than the first transfer mode, comprising:
specifying as a rotation speed of the disk medium a rotation speed higher than a predetermined rotation speed, which is used when the first transfer mode is specified, when the second transfer mode is specified; and
writing information to the disk medium by rotating the disk medium at the specified rotation speed.
